(19) United States
(12) Patent Application Publication
(10) Pub. No.: US 2026/0359006 A1
(43) Pub. Date: Nov. 12, 2026

(54) Matrix Multiplier Datapath with Split Multipliers and Shared Conversion/Normalization Circuitry

(71) Applicant: Apple Inc., Cupertino, CA (US)

(72) Inventors: Evan R. Lissoos, Austin, TX (US); Daniel E. Barnard, Hemel Hempstead (GB); Christopher A. Burns, Austin, TX (US)

(21) Appl. No.: 19/201,146

(22) Filed: May 7, 2025

(51) Int. Cl. G06F 7/499; G06F 17/16

(52) U.S. Cl. CPC G06F 7/49915; G06F 17/16

(57) ABSTRACT

Techniques are disclosed relating to matrix multiply accelerator circuitry. In some embodiments, the accelerator includes arithmetic logic unit (ALU) circuitry to perform a dot product operation on first and second inputs, where the arithmetic logic unit circuitry is to operate on both floating-point inputs and integer inputs. The ALU may include an integer pipeline portion that includes circuitry to perform multiplication operations on integer inputs to generate an integer output, a floating-point pipeline portion that includes circuitry to perform multiplication operations on floating-point mantissa inputs to generate a floating-point mantissa output, and conversion circuitry shared by the integer pipeline portion and floating-point pipeline portion. The conversion circuitry may convert an input value into a floating-point dot product result, including to: convert a given integer output from the integer pipeline portion and normalize a given floating-point mantissa output from the floating-point pipeline portion.

### BACKGROUND

### Technical Field

This disclosure relates generally to matrix multiply accelerators and more particularly to handling integer and floating-point inputs.

### Description of Related Art

Various computing algorithms utilize matrix multiplication, which may be accelerated in hardware. For example, various machine learning and artificial intelligence tasks utilize matrix multiplication. A given system may support multiple input formats, e.g., 8-bit floating-point (FP 8) and 8-bit integer (INT8) as well as higher-precision formats.

### BRIEF DESCRIPTION OF DRAWINGS

FIG. 1A is a diagram illustrating an overview of example graphics processing operations, according to some embodiments.

FIG. 1B is a block diagram illustrating an example graphics unit, according to some embodiments.

FIG. 2 is a block diagram illustrating an example datapath with split integer and floating-point multipliers and other shared circuitry, according to some embodiments.

FIG. 3 is a more detailed block diagram illustrating an example datapath, according to some embodiments.

FIG. 4 is a block diagram illustrating an example integer multiplier for dot product operations, according to some embodiments.

FIG. 5 is a block diagram illustrating an example floating-point multiplier for dot product operations, according to some embodiments.

FIG. 6 is a block diagram illustrating example shared normalization and fixed-to-float conversion circuitry, according to some embodiments.

FIG. 7 is a flow diagram illustrating an example method, according to some embodiments.

FIG. 8 is a block diagram illustrating an example computing device, according to some embodiments.

FIG. 9 is a diagram illustrating example applications of disclosed systems and devices, according to some embodiments.

FIG. 10 is a block diagram illustrating an example computer-readable medium that stores circuit design information, according to some embodiments.

### DETAILED DESCRIPTION

Generally, matrix multiplication may multiply two input matrices A and B using dot product operations (e.g., on vectors representing columns of A and rows of B). It may be desirable to share parts of a matrix accelerator's arithmetic logic unit (ALU) datapath for dot products for different input formats. For example, some implementations may share multiplier circuitry in the ALU for both multiplications of input matrices with INT8 elements and multiplications of input matrices with FP8 elements. This approach may have certain inefficiencies, however, because INT8 inputs will typically use the full multiplier width while FP8 inputs may have only 3 or 4 bits of mantissa to be multiplied. Completely separating the FP8 and INT8 datapaths may be inefficient in terms of circuit area, however.

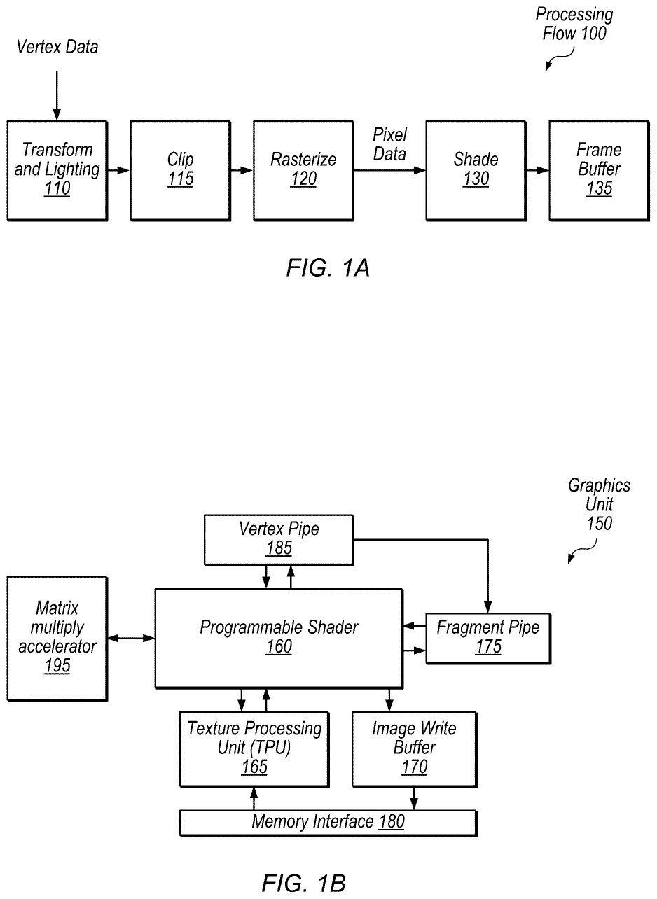

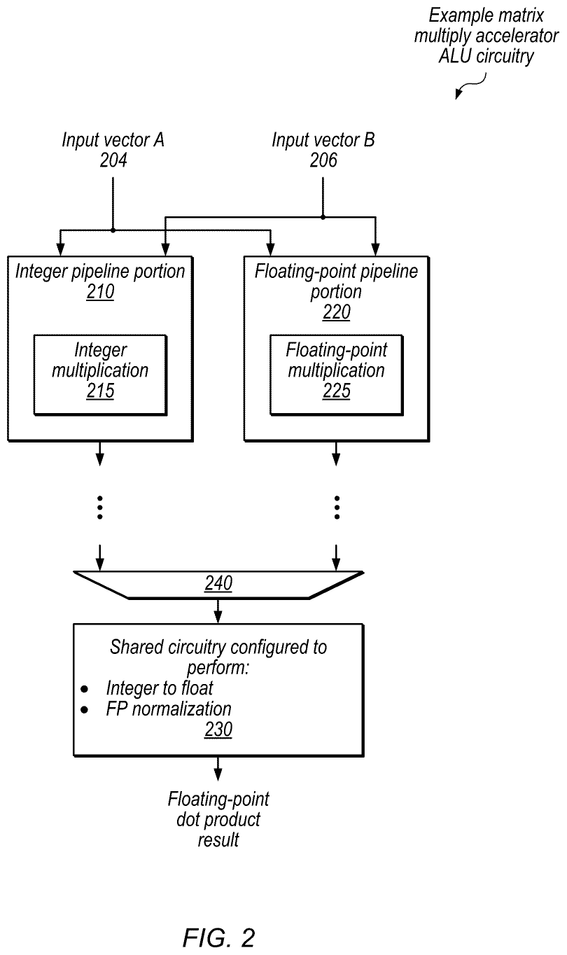

Therefore, in disclosed embodiments, the ALU datapath (see, e.g., ALU circuitry of FIG. 2) for a matrix multiply accelerator (see, e.g., matrix multiply accelerator 195 of FIG. 1B) includes separate multipliers for integer inputs and floating-point inputs while sharing other circuitry. For example, the shared circuitry may be configured to convert integer outputs to a floating-point format and perform floating-point normalization. This may advantageously allow the floating-point multipliers to be narrower than the integer multipliers, e.g., for the FP8 mantissas, while reducing overall circuit area compared to implementing separate datapaths. The integer and floating-point multipliers may have different topologies which may improve efficiency and provide desirable rounding behavior.

For example, the integer multiplier may be wider than the floating-point multiplier and may include a compression tree. The integer multiplier may also incorporate an accumulator input (e.g., a C input for the operation A*B+C) which may reduce power consumption in certain scenarios. The floating-point multiplier may include a level of multipliers, followed by shifters (e.g., to flatten products into full dynamic range), then compressors, then carry-propagate adders. This approach may provide fully-fused and accurate FP8 results, for example. The shared circuitry may include leading-zero detection/anticipation circuitry and left-shift circuitry, for example. In some embodiments, adder circuitry for the dot product operation is also shared.

### Graphics Processing Overview

Referring to FIG. 1A, a flow diagram illustrating an example processing flow 100 for processing graphics data is shown. In some embodiments, transform and lighting procedure 110 may involve processing lighting information for vertices received from an application based on defined light source locations, reflectance, etc., assembling the vertices into polygons (e.g., triangles), and transforming the polygons to the correct size and orientation based on position in a three-dimensional space. Clip procedure 115 may involve discarding polygons or vertices that fall outside of a viewable area. In some embodiments, geometry processing may utilize object shaders and mesh shaders for flexibility and efficient processing prior to rasterization. Rasterize procedure 120 may involve defining fragments within each polygon and assigning initial color values for each fragment, e.g., based on texture coordinates of the vertices of the polygon. Fragments may specify attributes for pixels which they overlap, but the actual pixel attributes may be determined based on combining multiple fragments (e.g., in a frame buffer), ignoring one or more fragments (e.g., if they are covered by other objects), or both. Shade procedure 130 may involve altering pixel components based on lighting, shadows, bump mapping, translucency, etc. Shaded pixels may be assembled in a frame buffer 135. Modern GPUs typically include programmable shaders that allow customization of shading and other processing procedures by application developers. Thus, in various embodiments, the example elements of FIG. 1A may be performed in various orders, performed in parallel, or omitted. Additional processing procedures may also be implemented.

Referring now to FIG. 1B, a simplified block diagram illustrating a graphics unit 150 is shown, according to some embodiments. In the illustrated embodiment, graphics unit 150 includes programmable shader 160, vertex pipe 185, fragment pipe 175, texture processing unit (TPU) 165, image write buffer 170, and memory interface 180. In some embodiments, graphics unit 150 is configured to process both vertex and fragment data using programmable shader 160, which may be configured to process graphics data in parallel using multiple execution pipelines or instances.

Vertex pipe 185, in the illustrated embodiment, may include various fixed-function hardware configured to process vertex data. Vertex pipe 185 may be configured to communicate with programmable shader 160 in order to coordinate vertex processing. In the illustrated embodiment, vertex pipe 185 is configured to send processed data to fragment pipe 175 or programmable shader 160 for further processing.

Fragment pipe 175, in the illustrated embodiment, may include various fixed-function hardware configured to process pixel data. Fragment pipe 175 may be configured to communicate with programmable shader 160 in order to coordinate fragment processing. Fragment pipe 175 may be configured to perform rasterization on polygons from vertex pipe 185 or programmable shader 160 to generate fragment data. Vertex pipe 185 and fragment pipe 175 may be coupled to memory interface 180 (coupling not shown) in order to access graphics data.

Programmable shader 160, in the illustrated embodiment, is configured to receive vertex data from vertex pipe 185 and fragment data from fragment pipe 175 and TPU 165. Programmable shader 160 may be configured to perform vertex processing tasks on vertex data which may include various transformations and adjustments of vertex data. Programmable shader 160, in the illustrated embodiment, is also configured to perform fragment processing tasks on pixel data such as texturing and shading, for example. Programmable shader 160 may include multiple sets of multiple execution pipelines for processing data in parallel.

In some embodiments, programmable shader includes pipelines configured to execute one or more different SIMD groups in parallel. Each pipeline may include various stages configured to perform operations in a given clock cycle, such as fetch, decode, issue, execute, etc. The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

The term “SIMD group” is intended to be interpreted according to its well-understood meaning, which includes a set of threads for which processing hardware processes the same instruction in parallel using different input data for the different threads. SIMD groups may also be referred to as SIMT (single-instruction, multiple-thread) groups, single instruction parallel thread (SIPT), or lane-stacked threads. Various types of computer processors may include sets of pipelines configured to execute SIMD instructions. For example, graphics processors often include programmable shader cores that are configured to execute instructions for a set of related threads in a SIMD fashion. Other examples of names that may be used for a SIMD group include: a wavefront, a clique, or a warp. A SIMD group may be a part of a larger threadgroup of threads that execute the same program, which may be broken up into a number of SIMD groups (within which threads may execute in lockstep) based on the parallel processing capabilities of a computer. In some embodiments, each thread is assigned to a hardware pipeline (which may be referred to as a “lane”) that fetches operands for that thread and performs the specified operations in parallel with other pipelines for the set of threads. Note that processors may have a large number of pipelines such that multiple separate SIMD groups may also execute in parallel. In some embodiments, each thread has private operand storage, e.g., in a register file. Thus, a read of a particular register from the register file may provide the version of the register for each thread in a SIMD group.

As used herein, the term “thread” includes its well-understood meaning in the art and refers to sequence of program instructions that can be scheduled for execution independently of other threads. Multiple threads may be included in a SIMD group to execute in lock-step. Multiple threads may be included in a task or process (which may correspond to a computer program). Threads of a given task may or may not share resources such as registers and memory. Thus, context switches may or may not be performed when switching between threads of the same task.

In some embodiments, multiple programmable shader units 160 are included in a GPU. In these embodiments, global control circuitry may assign work to the different sub-portions of the GPU which may in turn assign work to shader cores to be processed by shader pipelines.

TPU 165, in the illustrated embodiment, is configured to schedule fragment processing tasks from programmable shader 160. In some embodiments, TPU 165 is configured to pre-fetch texture data and assign initial colors to fragments for further processing by programmable shader 160 (e.g., via memory interface 180). TPU 165 may be configured to provide fragment components in normalized integer formats or floating-point formats, for example. In some embodiments, TPU 165 is configured to provide fragments in groups of four (a “fragment quad”) in a 2×2 format to be processed by a group of four execution pipelines in programmable shader 160.

Image write buffer 170, in some embodiments, is configured to store processed tiles of an image and may perform operations to a rendered image before it is transferred for display or to memory for storage. In some embodiments, graphics unit 150 is configured to perform tile-based deferred rendering (TBDR). In tile-based rendering, different portions of the screen space (e.g., squares or rectangles of pixels) may be processed separately. Memory interface 180 may facilitate communications with one or more of various memory hierarchies in various embodiments.

As discussed above, graphics processors typically include specialized circuitry configured to perform certain graphics processing operations requested by a computing system. This may include fixed-function vertex processing circuitry, pixel processing circuitry, or texture sampling circuitry, for example. Graphics processors may also execute non-graphics compute tasks that may use GPU shader cores but may not use fixed-function graphics hardware. As one example, machine learning workloads (which may include inference, training, or both) are often assigned to GPUs because of their parallel processing capabilities. Thus, compute kernels executed by the GPU may include program instructions that specify machine learning tasks such as implementing neural network layers or other aspects of machine learning models to be executed by GPU shaders. In some scenarios, non-graphics workloads may also utilize specialized graphics circuitry, e.g., for a different purpose than originally intended.

Further, various circuitry and techniques discussed herein with reference to graphics processors may be implemented in other types of processors in other embodiments. Other types of processors may include general-purpose processors such as CPUs or machine learning or artificial intelligence accelerators with specialized parallel processing capabilities. These other types of processors may not be configured to execute graphics instructions or perform graphics operations. For example, other types of processors may not include fixed-function hardware that is included in typical GPUs. Machine learning accelerators may include specialized hardware for certain operations such as implementing neural network layers or other aspects of machine learning models. Speaking generally, there may be design tradeoffs between the memory requirements, computation capabilities, power consumption, and programmability of machine learning accelerators. Therefore, different implementations may focus on different performance goals. Developers may select from among multiple potential hardware targets for a given machine learning application, e.g., from among generic processors, GPUs, and different specialized machine learning accelerators.

In the illustrated example, graphics unit 150 includes matrix multiply accelerator 195, which may include hardware configured to perform various matrix multiply operations in response to instruction(s) executed by programmable shader 160, as described in detail below. Note that while various ALU circuitry discussed in detail below may be included in accelerator 195, disclosed circuitry may be included in other circuitry in other embodiments, e.g., in a coprocessor of a CPU, in a stand-alone SOC client circuit, etc.

### Overview of Example Partially Shared Accelerator Datapath

FIG. 2 is a block diagram illustrating an example datapath with split integer and floating-point multipliers and other shared circuitry, according to some embodiments. In the illustrated example, a matrix multiply accelerator includes ALU circuitry with separate integer and floating-point pipeline portions 210 and 220. Note that the matrix accelerator may include a large number of ALUs configured to perform dot product operations of up to a certain size, which may make up parts of a larger overall matrix operation. In the illustrated example, input vector A 204 is an N-entry vector and input vector B 206 is also an N-entry vector. These vectors may correspond to a row and a column of the input matrices being multiplied (or a portion of a row and a portion of a column for a larger multiplication, which may involve multiple ALUs that receive different portions of a row/column).

The ALU in the illustrated example includes integer pipeline portion 210 with integer multiplication circuitry 215, floating-point pipeline portion 220 with floating-point multiplication circuitry 225, multiplexer (MUX) circuitry 240 and shared circuitry 230. As indicated by the ellipses, there may be additional stages between the split pipelines 210 and 220 and multiplexer 240, e.g., for adding multiplication results, which may be shared or independent.

For floating-point operations, the input vectors 204 and 206 include floating-point elements and are provided to floating-point pipeline portion 220. For integer operations, the input vectors 204 and 206 include integer elements and are provided to integer pipeline portion 210.

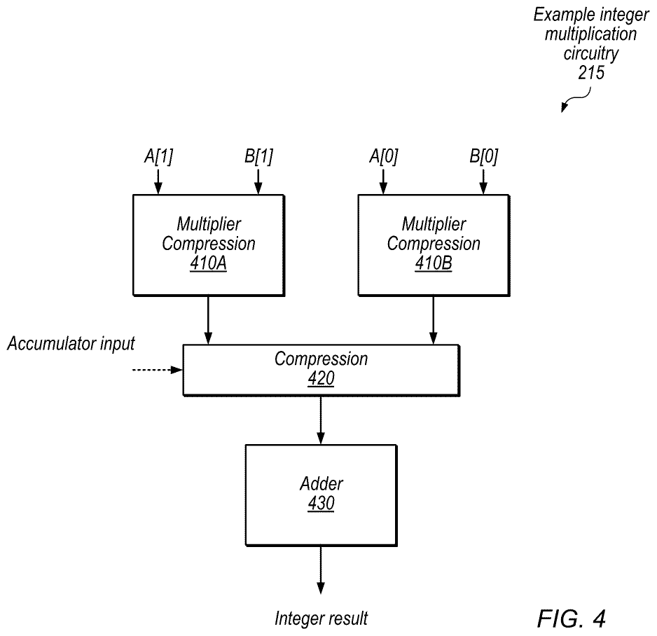

Integer pipeline portion 210 is configured to perform a dot product on integer (e.g., INT8) inputs, in some embodiments. A detailed example of integer multiplication is discussed below with reference to FIG. 4. Integer inputs are whole numbers and can be positive, negative, or zero. Note that fixed-point numbers are typically represented as integers but are fractional numbers where the position of the binary point is fixed, such that they have an implied scaling factor based on the fixed position. Therefore, various techniques discussed herein in the context of integers apply to fixed-point values and vice versa.

Floating-point pipeline 220 is configured to perform a dot product on floating-point (e.g., FP8) inputs, in some embodiments. Floating-point encodings represent numbers with fractional parts and the binary point can be positioned at different locations. For example, floating-point encodings typically include a sign field that indicates whether the number is positive or negative, an exponent field that indicates the scale of the number (e.g., in conjunction with a known bias), and a significand field (also referred to as a mantissa) that represents the significant digits of the number. Different floating-point formats may include different numbers of bits to provide different precisions. Also, floating-point formats that use the same number of bits may allocate the bits differently between the exponent and mantissa fields, e.g., to trade range for precision or vice versa.

The floating-point and integer inputs for different operations (e.g., elements of input vectors 204 and 206) may or may not include the same total number of bits. Similarly, the number of bits to be multiplied (e.g., all the integer bits and the floating-point mantissa) may be different for the different pipeline portions. For example, for 8-bit input values, eight integer bits may be multiplied while a smaller number of floating-point mantissa bits may be multiplied. Note that INT8 and FP8 formats are discussed herein for purposes of illustration, but disclosed techniques may be used with various integer widths (e.g., eight bit, 32-bit, 64-bit, etc.) and floating-point formats such as FP16, FP32, etc.

MUX 240, in some embodiments, is configured to select either an integer output or a floating-point output, e.g., based on information from the matrix multiply instruction being executed. Note that the illustrated ALU circuitry may be one of multiple ALUs configured to perform dot products for different portions of a larger matrix multiplication operations. Therefore, control circuitry (not shown) may decode a matrix multiply instruction/command and control multiple ALUs to perform parts of the overall operation (which may be an integer operation or a floating-point operation depending on the instruction/command).

Shared circuitry 230, in some embodiments, is configured to perform integer (or more generally, fixed-point) to floating-point conversion for outputs of the integer pipeline portion and is also configured to perform normalization for outputs of the floating-point pipeline portion. Shared circuitry 230 may or may not participate in rounding operations for floating-point in different embodiments. As shown, shared circuitry 230 is configured to generate a floating-point dot product result.

Note that various machine learning applications may perform matrix multiplication on integer values and convert results to floating-point for subsequent processing, e.g., using circuitry 230. This may include scaling and/or biasing for the next level of processing. In other situations, the integer result may be utilized without conversion, in which case circuitry 230 may be bypassed for a given integer computation.

### Detailed Example Pipeline and Separate Multipliers

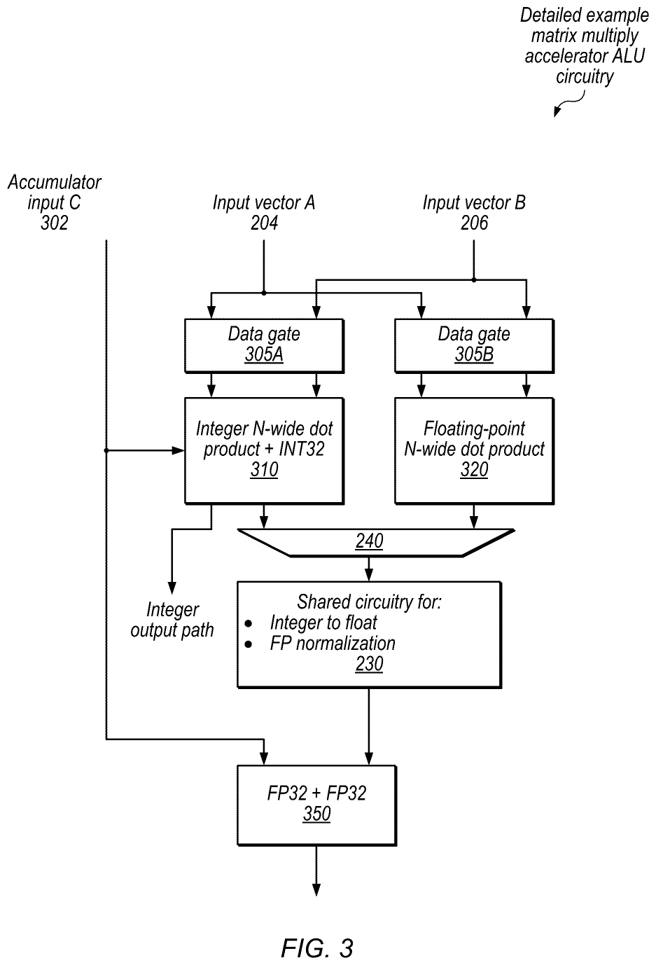

FIG. 3 is a more detailed block diagram illustrating an example datapath, according to some embodiments. Note that the circuitry of FIG. 3 is one example of the circuitry discussed above with reference to FIG. 2. In the illustrated example, the ALU includes data gates 305A and 305B, integer N-wide dot product+INT32 circuitry 310, floating-point N-wide dot product circuitry 320, MUX 240, shared circuitry 230, and FP32 adder circuitry 350. In some embodiments, all of the illustrated components are hardware components configured to perform operations for a portion of a matrix multiply instruction. For example, the instruction may be a GeMM instruction/command that indicates the operation C=αAB+βC, with A and B as matrix inputs, α and β as scalar inputs, and C as a pre-existing matrix which is overwritten by the output.

Data gates 305, in the illustrated example, are configured to gate the inputs to the unused side of the ALU (e.g., gate the inputs to circuitry 310 when performing a floating-point operation or gate the inputs to circuitry 320 when performing an integer operation). This may reduce dynamic power consumption on the unused side of the ALU.

Circuitry 310, in some embodiments, is configured to perform an N-wide integer dot product (e.g., on INT8 values) and add the result to the 32-bit accumulator input C 302. (In other embodiments, the accumulator addition may be performed later, e.g., by adder 350, but performing the accumulator addition as part of the dot product may reduce power consumption). A detailed example of circuitry 310 is provided below with reference to FIG. 4. As shown, circuitry 310 may provide its output to an integer output path when an integer result is desired. Otherwise, circuitry 310 provides its output to MUX 240 for conversion to floating-point by circuitry 230.

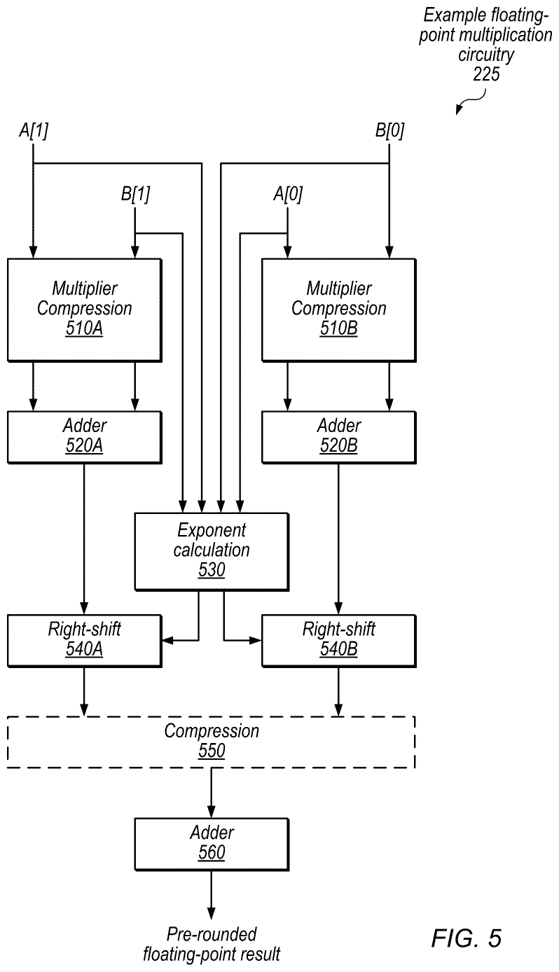

Circuitry 320, in some embodiments, is configured to perform an N-wide floating-point dot product (e.g., on FP8 values) and provide the result to MUX 240. A detailed example of circuitry 320 is provided below with reference to FIG. 5.

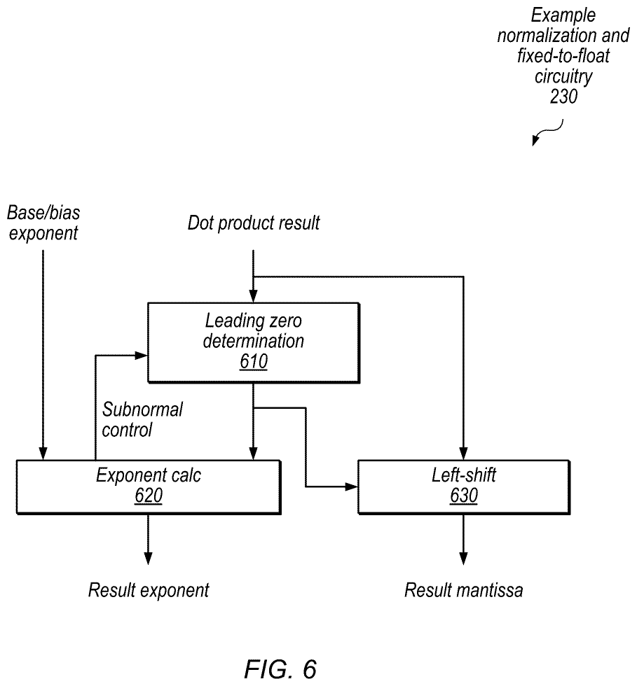

Shared circuitry 230 may be configured as discussed above with reference to FIG. 2. Shared circuitry 230 may receive a control signal (not explicitly shown) that indicates whether an integer or floating-point operation is being performed. MUX 240 and data gates 305 may be controlled by this same signal. A detailed example of circuitry 230 is provided below with reference to FIG. 6.

Adder circuitry 350, in the illustrated example, is configured to add two 32-bit floating-point inputs to generate a floating-point result for the GeMM operation for a matrix (or, typically, a portion of a result for a larger matrix). In other embodiments, the floating-point add may be fused into the dot product calculation earlier in the pipeline and adder circuitry 350 may be omitted.

Note that the circuitry of FIG. 3 may be configured to perform disclosed operations based on a single instruction (and these operations may be only a portion of the operations associated with performance of that instruction). While the mathematics behind dot product operations are well-understood, the specific way in which the disclosed circuitry performs these operations, particularly disclosed techniques with specific circuitry being shared or dedicated to either fixed-point or floating-point operations, may provide various technical advantages compared to traditional techniques (e.g., in terms of circuit area, performance, power consumption, etc.). Therefore, disclosed embodiments provide circuit-based solutions to technical problems arising in the technical field of circuit design for arithmetic logic units.

FIG. 4 is a block diagram illustrating an example integer multiplier, according to some embodiments. In the illustrated example, integer multiplication circuitry 215 includes compression circuitry 410A, 410B, and 420. Adder 430 is configured to add compression results to generate a dot product result.

Each element in the input vectors is an integer value, in some embodiment, e.g., wherein A[i] or B[i] represents an INT8 value. FIG. 4 shows a 2-wide dot product example for purposes of explanation, but similar compression trees may be utilized to perform dot products of various sizes. Therefore, it is to be understood that integer multipliers may include various numbers of compressors per level and various numbers of compressor levels in the compression tree.

Compressor circuits are well understood by those of skill in the art and are configured to combine multiple input bits into a smaller number of output bits. This may effectively reduce the number of carries generated during binary arithmetic operations. A tree of compressors may be configured to perform multiplication of input vector values, as shown.

As shown, compression circuitry 420 receives the outputs of compression circuitry 410A and 420B. Generally a compressor at a given level in the tree receives outputs from compressors in a higher level as inputs.

In the illustrated example, the dashed input of one or more accumulator bits allows addition of the accumulator as part of the dot product. Thus, accumulator bit(s) may be added in at various levels as the multiplication proceeds down the tree. This may reduce power consumption compared to adding the accumulator value after conversion to floating-point, when an integer final result is desired. In other embodiments, circuitry 215 may be implemented as a multiplier without accumulation.

Adder 430, in some embodiments, is configured to add output bits from the last level of compression to generate a dot product result for the input vectors.

FIG. 5 is a block diagram illustrating an example floating-point multiplier, according to some embodiments. In the illustrated example, floating-point multiplication circuitry 225 includes compression circuitry 510A, 510B, and 550, adder circuitry 520A, 520B, and 560, exponent calculation circuitry 530, and right shift circuitry 540A and 540B.

Each element in the input vectors is a floating-point value, in some embodiment, e.g., wherein A[i] or B[i] represents an FP8 value. FIG. 5 shows a 2-wide dot product example for purposes of explanation, but similar topologies may be utilized to perform dot products of various sizes. Therefore, it is to be understood that floating-point multipliers may include various numbers of compressors, widths of adders and shifters, number of levels, etc.

Multiplier compression circuitry 510A and 510B, in some embodiments, is configured to receive mantissa portions of input values from the input vectors and generate compression results for adders 520A and 520B, which are configured to add the results to generate an initial mantissa multiplication result.

Exponent calculation circuitry 530 receives information from the input values and determines an exponent result and a right-shift value for the mantissa results, which it provides to right-shift circuit 540A and 540B. Exponent calculation circuitry 530 may perform different calculations in different embodiments. For example, in an anchored implementation, circuitry 530 may perform a max reduction to find the largest product exponent followed by a different of that exponent by each individual exponent. As another example, in a flattened implementation, the calculation may be based on each product's exponent.

The right-shift circuitry 540 shifts the results as controlled by the exponent calculation circuitry 530 and provides the results to compression circuitry 550, which compresses the results prior to a final add. Note that circuitry 550 is shown using dashed lines because it may not be needed for the illustrated 2-wide dot product, but such compression circuitry may be utilized for wider dot product computations in various embodiments. Adder 560 generates a pre-rounded floating-point dot product result (e.g., using carry-propagate addition). Note that the disclosed circuitry may provide a fused and properly rounded dot product result (where “fused” refers to utilizing a single rounding, which may improve accuracy and performance compared to performing rounding for multiple intermediate results).

In some embodiments, the number of bits of a given integer input (e.g., A[i] or B[i]) on the integer side of the ALU are greater than the number of bits for floating-point multiplier inputs on the floating-point side. For example, INT8 inputs to the circuitry of FIG. 4 may be eight bits each in an embodiment in which the FP8 multiplier inputs (mantissa fields) to the circuitry of FIG. 5 are three bits (e.g., the E4M3 variant) or two bits (e.g., the E5M2 variant).

In other embodiments, other topologies may be used for the integer side of the ALU instead of a compressor tree and other topologies may be used for the floating-point side of the ALU instead of the topology of FIG. 5. Generally, however, using a different width, topology, or both for the integer side multiplier may improve efficiency compared to sharing multiplier circuitry for the integer and floating-point sides.

Note that in some embodiments, all or a portion of adder 430 and adder 560 are shared by the integer and floating-point sides of the ALU (e.g., they may be the same adder or one may be a portion of the other). In other embodiments, these two adders are independent. Note that combining these adders may reduce circuit area while utilizing separate adders may reduce power consumption (e.g., by tailoring the adder design for each path separately).

### Detailed Examples of Shared Circuitry

FIG. 6 is a block diagram illustrating example shared normalization and fixed-to-float conversion circuitry, according to some embodiments. In the illustrated example, circuitry 230 includes leading zero determination circuitry 610, exponent calculation circuitry 620, and left-shift circuitry 630. As discussed above, circuitry 230 may be shared for both (A) converting results of the dot product calculations from the integer side of the ALU to floating-point and (B) normalizing dot product results from the floating-point side of the ALU.

Leading zero determination circuitry 610, in some embodiments, is configured to calculate or anticipate leading zeros in the dot product result (e.g., in the mantissa of a result from the floating-point side or in a fixed-point result from the integer side) and provide this information to exponent calculation 620.

Exponent calculation 620, in some embodiments, receives information indicate the base exponent (e.g., for the floating-point side) or the bias exponent (e.g., for the integer side) and determine a result exponent based on the results from the leading zero determination circuitry 610. Exponent circuitry 620 also controls left-shift circuitry 630 to properly shift the input mantissa or fixed-point value to generate a result mantissa. For subnormal results, exponent circuitry 620 may signal to circuitry 610 to saturate in order to avoid a negative exponent (shown as subnormal control in FIG. 6). Circuitry 230 may also properly generate the sign of the floating-point result (not explicitly shown).

In some embodiments, circuitry 230 includes right-shift circuitry (e.g., in parallel with left-shift circuitry 630) that is not shown in FIG. 6. This right-shift circuitry may be utilized for situations where a negative exponent result is found for the dot product result. In this situation, the right-shift circuitry may shift for a denormalization operation, based on control signaling from exponent calculation circuitry 620. This right-shift circuitry may also be utilized for integer dot products with scale factors that cause a similar situation. In other embodiments, the system may be configured not to handle these cases and may instead output a special value, a value whose accuracy is not guaranteed, or an error signal, for example.

In various embodiments, sharing the circuitry to FIG. 6 may advantageously reduce circuit area while facilitating benefits discussed above relating to using different multiplier topologies for integer and floating-point sides of the ALU.

### Example Method

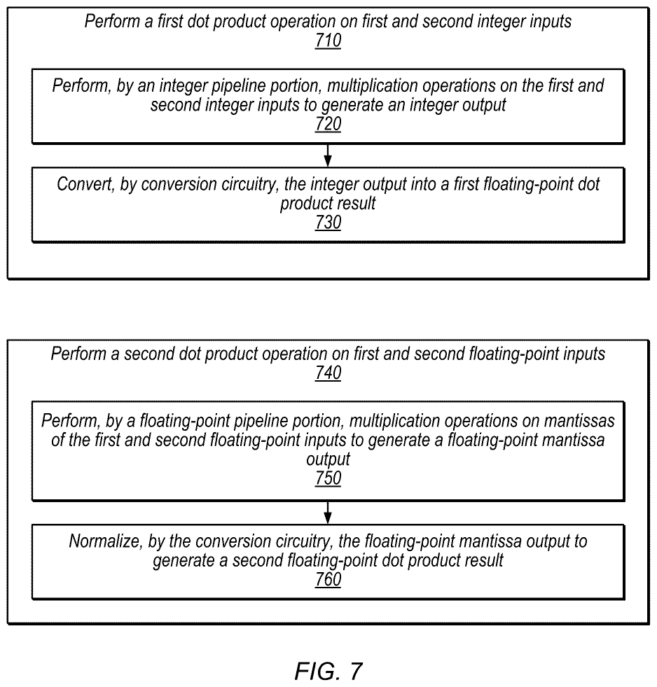

FIG. 7 is a flow diagram illustrating an example method, according to some embodiments. The method shown in FIG. 7 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

Note that elements 710 and 740 may be performed sequentially, in a pipelined fashion, using one instance of the disclosed ALU, in either order. Further, elements 710 and 740 may be performed in parallel using different instances of the disclosed ALU.

At 710, in the illustrated embodiment, an arithmetic logic unit of a matrix multiply accelerator performs a first dot product operation on first and second integer inputs. In the illustrated example this includes elements 720 and 730.

At 720, in the illustrated embodiment, an integer pipeline portion performs multiplication operations on the first and second integer inputs to generate an integer output.

At 730, in the illustrated embodiment, conversion circuitry converts the integer output into a first floating-point dot product result.

At 740, in the illustrated embodiment, the arithmetic logic unit performs a second dot product operation on first and second floating-point units. In the illustrated example, this includes elements 750 and 760.

At 750, in the illustrated embodiment, a floating-point pipeline portion performs multiplication operations on mantissas of the first and second floating-point inputs to generate a floating-point mantissa output.

At 760, in the illustrated embodiment, the conversion circuitry normalizes the floating-point mantissa output to generate a second floating-point dot product result.

In some embodiments, the floating-point pipeline portion includes a first compression stage (e.g., 510), an adder stage (e.g., 520) to operate on outputs of the first compression stage, a right-shift stage (e.g., 540) to operate on outputs of the adder stage, and a second compression stage (e.g., 550) to operate on outputs of the right-shift stage. In some embodiments, the floating-point pipeline portion includes exponent calculation circuitry (e.g., 530) to control the right-shift stage.

In some embodiments, to perform the multiplication operations for integer inputs, the integer pipeline portion includes: a tree of compressor circuits with multiple levels (e.g., 410 and 420) and adder circuitry (e.g., 430) to generate an integer dot product result based on an output of the tree of compressor circuits.

In some embodiments, control circuitry is configured to determine a base exponent (e.g., the base/bias exponent to circuitry 620) for conversion of the floating-point output into the floating-point dot product result based on a general matrix multiply instruction. In some embodiments, the matrix multiply accelerator circuitry also includes one or more other instances of the arithmetic logic unit circuitry and the control circuitry is also to use the determined base exponent for the one or more other instances of the arithmetic logic unit circuitry to perform the general matrix multiply instruction.

In some embodiments, the integer inputs have N bits per input, where N is an integer and the floating-point mantissa inputs have less than N bits per input. In some embodiments, the integer inputs are 8-bit integer values and the floating-point mantissa inputs are included in 8-bit, 6-bit, or 4-bit floating point values.

In some embodiments, the arithmetic logic unit circuitry further includes floating-point adder circuitry (e.g., 350) configured to add an accumulated value to an output of the conversion circuitry. In some embodiments, the arithmetic logic unit circuitry is to operate on a portion of input matrices for an overall matrix multiplication operation and is one of multiple arithmetic logic units included in the matrix multiply accelerator circuitry and to operate on different portions of the input matrices.

In some embodiments, the arithmetic logic unit circuitry further includes shared adder circuitry (e.g., adders 430 and 560 may be the same adder or may include shared circuitry) to generate a dot product input to the conversion circuitry based on either an output of the integer pipeline portion of an output of the floating-point pipeline portion.

In some embodiments, the conversion circuitry includes leading zero detection circuitry (e.g., 610), exponent calculation circuitry (e.g., 620), and left-shift control circuitry (e.g., 630) configured to generate a mantissa of the floating-point dot product result, where the left-shift control circuitry is controlled based on an output of the leading zero detection circuitry.

The concept of “execution” is broad and may refer to 1) processing of an instruction throughout an execution pipeline (e.g., through fetch, decode, execute, and retire stages) and 2) processing of an instruction at an execution unit or execution subsystem of such a pipeline (e.g., an integer execution unit or a load-store unit). The latter meaning may also be referred to as “performing” the instruction. Thus, “performing” an add instruction refers to adding two operands to produce a result, which may, in some embodiments, be accomplished by a circuit at an execute stage of a pipeline (e.g., an execution unit). Conversely, “executing” the add instruction may refer to the entirety of operations that occur throughout the pipeline as a result of the add instruction. Similarly, “performing” a “load” instruction may include retrieving a value (e.g., from a cache, memory, or stored result of another instruction) and storing the retrieved value into a register or other location.

As used herein the terms “complete” and “completion” in the context of an instruction refer to commitment of the instruction's result(s) to the architectural state of a processor or processing element. For example, completion of an add instruction includes writing the result of the add instruction to a destination register. Similarly, completion of a load instruction includes writing a value (e.g., a value retrieved from a cache or memory) to a destination register or a representation thereof.

The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

### Example Device

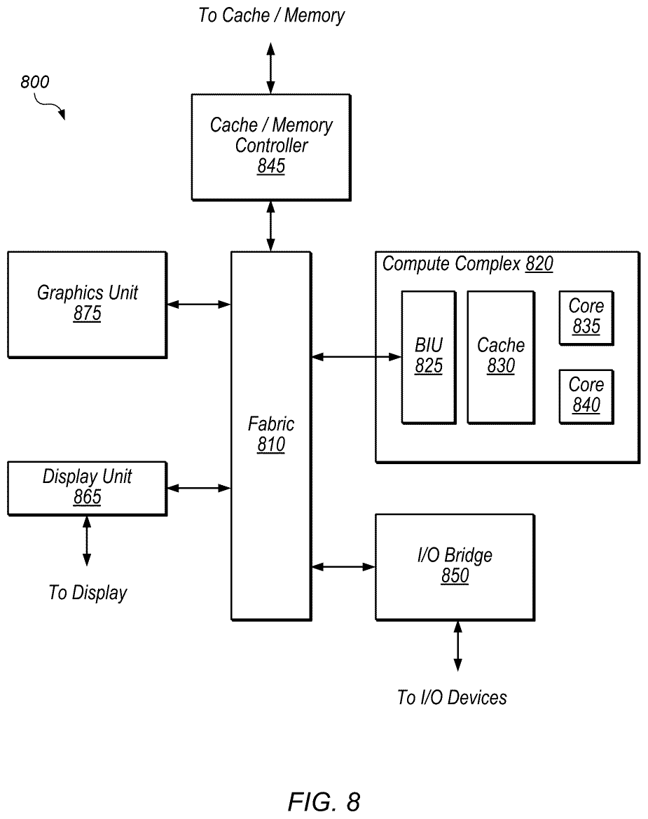

Referring now to FIG. 8, a block diagram illustrating an example embodiment of a device 800 is shown. In some embodiments, elements of device 800 may be included within a system on a chip. In some embodiments, device 800 may be included in a mobile device, which may be battery-powered. Therefore, power consumption by device 800 may be an important design consideration. In the illustrated embodiment, device 800 includes fabric 810, compute complex 820 input/output (I/O) bridge 850, cache/memory controller 845, graphics unit 875, and display unit 865. In some embodiments, device 800 may include other components (not shown) in addition to or in place of the illustrated components, such as video processor encoders and decoders, image processing or recognition elements, computer vision elements, etc.

Fabric 810 may include various interconnects, buses, MUX's, controllers, etc., and may be configured to facilitate communication between various elements of device 800. In some embodiments, portions of fabric 810 may be configured to implement various different communication protocols. In other embodiments, fabric 810 may implement a single communication protocol and elements coupled to fabric 810 may convert from the single communication protocol to other communication protocols internally.

In the illustrated embodiment, compute complex 820 includes bus interface unit (BIU) 825, cache 830, and cores 835 and 840. In various embodiments, compute complex 820 may include various numbers of processors, processor cores and caches. For example, compute complex 820 may include 1, 2, or 4 processor cores, or any other suitable number. In one embodiment, cache 830 is a set associative L2 cache. In some embodiments, cores 835 and 840 may include internal instruction and data caches. In some embodiments, a coherency unit (not shown) in fabric 810, cache 830, or elsewhere in device 800 may be configured to maintain coherency between various caches of device 800. BIU 825 may be configured to manage communication between compute complex 820 and other elements of device 800. Processor cores such as cores 835 and 840 may be configured to execute instructions of a particular instruction set architecture (ISA) which may include operating system instructions and user application instructions. These instructions may be stored in computer readable medium such as a memory coupled to memory controller 845 discussed below.

As used herein, the term “coupled to” may indicate one or more connections between elements, and a coupling may include intervening elements. For example, in FIG. 8, graphics unit 875 may be described as “coupled to” a memory through fabric 810 and cache/memory controller 845. In contrast, in the illustrated embodiment of FIG. 8, graphics unit 875 is “directly coupled” to fabric 810 because there are no intervening elements.

Cache/memory controller 845 may be configured to manage transfer of data between fabric 810 and one or more caches and memories. For example, cache/memory controller 845 may be coupled to an L3 cache, which may in turn be coupled to a system memory. In other embodiments, cache/memory controller 845 may be directly coupled to a memory. In some embodiments, cache/memory controller 845 may include one or more internal caches. Memory coupled to controller 845 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 845 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 820 to cause the computing device to perform functionality described herein.

Graphics unit 875 may include one or more processors, e.g., one or more graphics processing units (GPUs). Graphics unit 875 may receive graphics-oriented instructions, such as VULKAN®, Metal®, or DIRECTX® instructions, for example. Graphics unit 875 may execute specialized GPU instructions or perform other operations based on the received graphics-oriented instructions. Graphics unit 875 may generally be configured to process large blocks of data in parallel and may build images in a frame buffer for output to a display, which may be included in the device or may be a separate device. Graphics unit 875 may include transform, lighting, triangle, and rendering engines in one or more graphics processing pipelines. Graphics unit 875 may output pixel information for display images. Graphics unit 875, in various embodiments, may include programmable shader circuitry which may include highly parallel execution cores configured to execute graphics programs, which may include pixel tasks, vertex tasks, and compute tasks (which may or may not be graphics-related).

In some embodiments, disclosed techniques may reduce power consumption, improve performance, or both of graphics unit 875 (or another matrix multiply accelerator of the system) for matrix processing operations), e.g., compared to a fully shared integer and floating-point pipeline. Disclosed techniques may reduce circuit area, e.g., compared to fully independent integer and floating-point pipelines.

Display unit 865 may be configured to read data from a frame buffer and provide a stream of pixel values for display. Display unit 865 may be configured as a display pipeline in some embodiments. Additionally, display unit 865 may be configured to blend multiple frames to produce an output frame. Further, display unit 865 may include one or more interfaces (e.g., MIPI® or embedded display port (eDP)) for coupling to a user display (e.g., a touchscreen or an external display).

I/O bridge 850 may include various elements configured to implement: universal serial bus (USB) communications, security, audio, and low-power always-on functionality, for example. I/O bridge 850 may also include interfaces such as pulse-width modulation (PWM), general-purpose input/output (GPIO), serial peripheral interface (SPI), and inter-integrated circuit (I2C), for example. Various types of peripherals and devices may be coupled to device 800 via I/O bridge 850.

In some embodiments, device 800 includes network interface circuitry (not explicitly shown), which may be connected to fabric 810 or I/O bridge 850. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 800 with connectivity to various types of other devices and networks.

### Example Applications

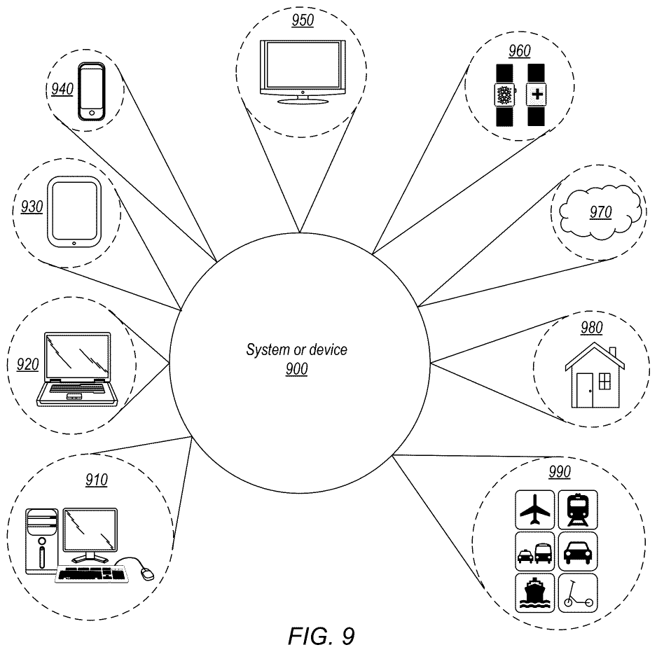

Turning now to FIG. 9, various types of systems that may include any of the circuits, devices, or system discussed above. System or device 900, which may incorporate or otherwise utilize one or more of the techniques described herein, may be utilized in a wide range of areas. For example, system or device 900 may be utilized as part of the hardware of systems such as a desktop computer 910, laptop computer 920, tablet computer 930, cellular or mobile phone 940, or television 950 (or set-top box coupled to a television).

Similarly, disclosed elements may be utilized in a wearable device 960, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 900 may also be used in various other contexts. For example, system or device 900 may be utilized in the context of a server computer system, such as a dedicated server or on shared hardware that implements a cloud-based service 970. Still further, system or device 900 may be implemented in a wide range of specialized everyday devices, including devices 980 commonly found in the home such as refrigerators, thermostats, security cameras, etc. The interconnection of such devices is often referred to as the “Internet of Things” (IoT). Elements may also be implemented in various modes of transportation. For example, system or device 900 could be employed in the control systems, guidance systems, entertainment systems, etc. of various types of vehicles 990.

The applications illustrated in FIG. 9 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

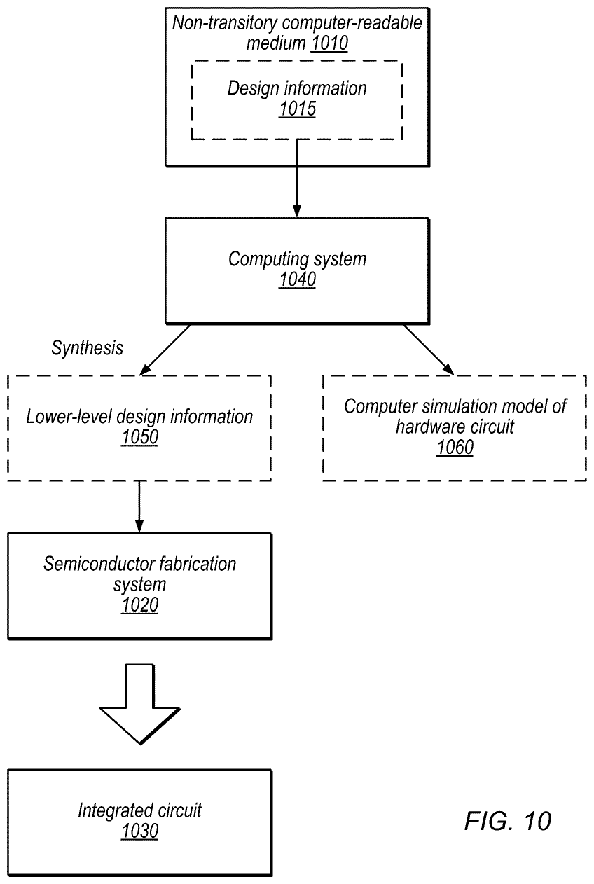

FIG. 10 is a block diagram illustrating an example non-transitory computer-readable storage medium that stores circuit design information, according to some embodiments. In the illustrated embodiment, computing system 1040 is configured to process the design information. This may include executing instructions included in the design information, interpreting instructions included in the design information, compiling, transforming, or otherwise updating the design information, etc. Therefore, the design information controls computing system 1040 (e.g., by programming computing system 1040) to perform various operations discussed below, in some embodiments.

In the illustrated example, computing system 1040 processes the design information to generate both a computer simulation model of a hardware circuit 1060 and lower-level design information 1050. In other embodiments, computing system 1040 may generate only one of these outputs, may generate other outputs based on the design information, or both. Regarding the computing simulation, computing system 1040 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 1040 also processes the design information to generate lower-level design information 1050 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 1050 (potentially among other inputs), semiconductor fabrication system 1020 is configured to fabricate an integrated circuit 1030 (which may correspond to functionality of the simulation model 1060). Note that computing system 1040 may generate different simulation models based on design information at various levels of description, including information 1050, 1015, and so on. The data representing design information 1050 and model 1060 may be stored on medium 1010 or on one or more other media.

In some embodiments, the lower-level design information 1050 controls (e.g., programs) the semiconductor fabrication system 1020 to fabricate the integrated circuit 1030. Thus, when processed by the fabrication system, the design information may program the fabrication system to fabricate a circuit that includes various circuitry disclosed herein.

Non-transitory computer-readable storage medium 1010, may comprise any of various appropriate types of memory devices or storage devices. Non-transitory computer-readable storage medium 1010 may be an installation medium, e.g., a CD-ROM, floppy disks, or tape device; a computer system memory or random access memory such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. Non-transitory computer-readable storage medium 1010 may include other types of non-transitory memory as well or combinations thereof. Accordingly, non-transitory computer-readable storage medium 1010 may include two or more memory media; such media may reside in different locations—for example, in different computer systems that are connected over a network.

Design information 1015 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 1040, semiconductor fabrication system 1020, or both. In some embodiments, design information may also include one or more cell libraries that specify the synthesis, layout, or both of integrated circuit 1030. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1030 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1020 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1020 may also be configured to perform various testing of fabricated circuits for correct operation.

In various embodiments, integrated circuit 1030 and model 1060 are configured to operate according to a circuit design specified by design information 1015, which may include performing any of the functionality described herein. For example, integrated circuit 1030 may include any of various elements shown in FIGS. 1B-6. Further, integrated circuit 1030 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 1020 to fabricate integrated circuit 1030.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured to” or “to” perform one or more tasks or operations. These formulations—[entity] configured to [perform one or more tasks]—or—[entity] to [perform one or more tasks]—are used herein to refer to structure (i.e., something physical). More specifically, these formulations are used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. These phrases are not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” or “to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
an integer pipeline portion that includes circuitry to perform multiplication operations on integer inputs to generate an integer output for an integer dot product operation;
a floating-point pipeline portion that includes circuitry to perform multiplication operations on floating-point mantissa inputs to generate a floating-point mantissa output for a floating-point dot product operation; and
conversion circuitry shared by the integer pipeline portion and floating-point pipeline portion, wherein the conversion circuitry is to process a received value to generate a floating-point dot product result, including to:
convert the integer output from the integer pipeline portion; and
normalize the floating-point mantissa output from the floating-point pipeline portion.

2. The apparatus of claim 1, wherein the floating-point pipeline portion includes a first compression stage, an adder stage to operate on outputs of the first compression stage, a right-shift stage to operate on outputs of the adder stage, and a second compression stage to operate on outputs of the right-shift stage.

3. The apparatus of claim 2, wherein the floating-point pipeline portion includes exponent calculation circuitry to control the right-shift stage.

4. The apparatus of claim 2, wherein, to perform the multiplication operations for integer inputs, the integer pipeline portion includes:
a tree of compressor circuits with multiple levels; and
adder circuitry to generate an integer dot product result based on an output of the tree of compressor circuits.

5. The apparatus of claim 1, further comprising:
control circuitry to determine a base exponent for conversion of the floating-point output into the floating-point dot product result based on a general matrix multiply instruction.

6. The apparatus of claim 5, wherein:
the integer pipeline portion, the floating-point pipeline portion, and the conversion circuitry are included in arithmetic logic unit circuitry of a matrix multiply accelerator; and
the matrix multiply accelerator also includes one or more other instances of the arithmetic logic unit circuitry, wherein the control circuitry is also to use the determined base exponent for the one or more other instances of the arithmetic logic unit circuitry to perform the general matrix multiply instruction.

7. The apparatus of claim 1, wherein:
the integer inputs have N bits per input, where N is an integer; and
the floating-point mantissa inputs have less than N bits per input.

8. The apparatus of claim 7, wherein the integer inputs are 8-bit integer values and the floating-point mantissa inputs are included in 8-bit, 6-bit, or 4-bit floating point values.

9. The apparatus of claim 1, further comprising:
floating-point adder circuitry to add an accumulated value to an output of the conversion circuitry.

10. The apparatus of claim 1, wherein:
the integer pipeline portion, the floating-point pipeline portion, and the conversion circuitry are included in arithmetic logic unit circuitry of a matrix multiply accelerator; and
the arithmetic logic unit circuitry is to operate on a portion of input matrices for an overall matrix multiplication operation and is one of multiple arithmetic logic units included in the matrix multiply accelerator and to operate on different portions of the input matrices.

11. The apparatus of claim 1 further comprising:
shared adder circuitry to generate a dot product input to the conversion circuitry based on either an output of the integer pipeline portion of an output of the floating-point pipeline portion.

12. The apparatus of claim 1, wherein the conversion circuitry includes:
leading zero detection circuitry;
exponent calculation circuitry; and
left-shift control circuitry to generate a mantissa of the floating-point dot product result, wherein the left-shift control circuitry is controlled based on an output of the leading zero detection circuitry.

13. The apparatus of claim 1, wherein the integer pipeline portion, the floating-point pipeline portion, and the conversion circuitry are included in a graphics processor of the apparatus.

14. The apparatus of claim 1, wherein the apparatus is a computing device that further comprises:
a display;
a central processing unit; and
a network interface.

15. A method, comprising:
performing, by an arithmetic logic unit of a matrix multiply accelerator, a first dot product operation on first and second integer inputs, including:
performing, by an integer pipeline portion of the arithmetic logic unit, multiplication operations on the first and second integer inputs to generate an integer output; and
converting, by conversion circuitry shared by the integer pipeline portion and a floating-point pipeline portion of the arithmetic logic unit, the integer output into a first floating-point dot product result;
performing, by the arithmetic logic unit, a second dot product operation on first and second floating-point units, including:
performing, by the floating-point pipeline portion, multiplication operations on mantissas of the first and second floating-point inputs to generate a floating-point mantissa output; and
normalizing, by the conversion circuitry, the floating-point mantissa output to generate a second floating-point dot product result.

16. The method of claim 15, wherein:
the performing the multiplication operations on the mantissas of the first and second floating-point inputs includes a compression stage, an adder stage, a right-shift stage, and a second compression stage; and
the performing the multiplication operations on the first and second integer inputs includes utilizing a multi-level tree of compression circuits and an adder stage that operates on outputs of the multi-level tree.

17. The method of claim 15, wherein:
the integer inputs have N bits per input, where N is an integer; and
the floating-point mantissa inputs have less than N bits per input.

18. The method of claim 15, further comprising:
adding, by floating-point adder circuitry, an accumulated value to an output of the conversion circuitry.

19. The method of claim 15, further comprising:
generating, by shared adder circuitry, a first dot product input to the conversion circuitry based on an output of the integer pipeline portion and a second dot product input to the conversion circuitry based on an output of the floating-point pipeline portion.

20. A non-transitory computer-readable medium having instructions of a hardware description programming language stored thereon that, when processed by a computing system, program the computing system to generate a computer simulation model, wherein the model represents a hardware circuit that includes:
an integer pipeline portion that includes circuitry to perform multiplication operations on integer inputs to generate an integer output for an integer dot product operation;
a floating-point pipeline portion that includes circuitry to perform multiplication operations on floating-point mantissa inputs to generate a floating-point mantissa output for a floating-point dot product operation; and
conversion circuitry shared by the integer pipeline portion and floating-point pipeline portion, wherein the conversion circuitry is to process a received value to generate a floating-point dot product result, including to:
convert the integer output from the integer pipeline portion; and
normalize the floating-point mantissa output from the floating-point pipeline portion.
